(19) United States
(12) Patent Application Publication
(10) Pub. No.: US 2014/0191667 A1
(43) Pub. Date: Jul. 10, 2014

(54) LIGHT SOURCE CONTROLLER

(71) Applicant: Oldenburg Group Incorporated, Glendale, WI (US)

(72) Inventor: Christopher M. Glandt, Shorewood, WI (US)

(73) Assignee: Oldenburg Group Incorporated, Glendale, WI (US)

(21) Appl. No.: 14/146,855

(22) Filed: Jan. 3, 2014

Related U.S. Application Data
(60) Provisional application No. 61/848,574, filed on Jan. 8, 2013.

(51) Int. Cl. H05B 33/08

(52) U.S. Cl. CPC H05B 33/0854
USPC 315/158

(57) ABSTRACT

A light source control system using output feedback, comparing the current output to a previous output level of a light source and modulating a control signal to maintain the light source output at a predetermined percentage of its maximum.

### CROSS-REFERENCE TO RELATED PATENT APPLICATIONS

This patent application is a non-provisional application which claims the benefit to U.S. Provisional Patent Application No. 61/848,574, filed Jan. 8, 2013, entitled “Light Source Controller,” which patent application is assigned to the assignee of the present invention, and which patent application is hereby incorporated herein by this reference in its entirety.

### BACKGROUND OF THE INVENTION

1. Field of the Invention

The present disclosure is in the technical field of lighting. More particularly, the present disclosure is in the technical field of light emitting diodes used for lighting. More particularly, the present disclosure is in the technical field of controlling the amount of luminous flux generated by one or more light emitting diodes within a light source output at a predetermined percentage of the light source rated maximum.

Lighting fixtures using light emitting diodes as a light source offer many potential benefits, including energy savings, reduction of hazardous substance waste, and greater convenience through reduced maintenance and replacement due to the greatly extended life compared to lighting fixtures using traditional light sources.

Conventional light emitting diode light sources have a wear-out characteristic that is defined by a slow reduction in the amount of light produced over a long period of time. Because of this reduction in output, it is necessary to use 10-30% more light emitting diode sources than needed to illuminate a space, so that when the light emitting diode sources have decreased their output to a predetermined amount there will still be sufficient illumination in said space. Due to this over-lighting, the amount of power consumed to illuminate a space is increased by 10-30% to compensate for the decrease in output over time.

Light emitting diodes (or LEDs) do not fail in the same manner as other common sources of light. Incandescent, fluorescent, and high-intensity discharge sources are generally assumed to be at the end of their lives when they “go out,” or fail. Unlike these sources, the output of an LED slowly declines over time, such that very little light is emitted from the LED by the time it reaches its thermal or mechanical limits. Provided the mechanical, thermal, and electrical support systems are managed properly, an LED may operate for hundreds of thousands of hours before ceasing to emit perceptible light. Based on this fact, the lighting industry has agreed that when used as a light source, an LED has reached the end of its useful life when its output has decreased 30% from its initial output. This is commonly referred to as “L₇₀” life, so named as the LED light source is producing 70% of its initial output.

This does, however, create a problem for users of LED light fixtures. Accepted practice is to design the lighting for the majority of spaces based on the minimum amount of light (luminous flux) that a light source will emit during its useful life. By doing so, the user of the space has reasonable certainty that the amount of light in the space will not drop below what is required for the task, provided the space and light fixtures are properly maintained.

Since all light sources' output decreases over time, proper maintenance often includes replacement of sources that have reduced in lumen output below a specified threshold (such as L₇₀). Unfortunately, such maintenance relies on diligent adherence to a maintenance schedule. Such maintenance plans are frequently disregarded, and therefore sources are often replaced only when they completely cease operation, rather than on a periodic basis to preserve the quality of lighting within a space.

This creates a problem for lighting fixtures using LED light sources, which do not have a normal complete failure mode (provided that the LED light sources are operated within manufacturer's guidelines). If the user of a space does not follow the recommended schedule for replacement of the LED light sources (replacement after a certain period of time equivalent to L₇₀ life), the sources may fade to a point that the lighting is inappropriate long before the LED light sources fail completely and are changed. Such a situation can cause, among other outcomes, reduced productivity, occupant discomfort, injury, and even death (in certain circumstances) when the lighting becomes too dim for its intended use.

Though the practice of using a light-sensitive element (light sensor) to detect the amount of light emitted from a lighting system is not a new concept, the form factor and manufacturing means required for the construction of an LED lighting fixture creates difficulty in placement of the light sensitive element. Further difficulty is introduced by the fact that most light fixtures operate in a space where there are other light-emitting elements, thus possibly contributing to the amount of light measured by a light sensor and introducing error into any intended measurement of the luminous flux produced by a light fixture.

The subject matter discussed in this background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

The apparatus disclosed must also be of construction which is both durable and long lasting, and it should also require little or no maintenance to be provided by the user throughout its operating lifetime. In order to enhance the market appeal of the apparatus, it should also be of inexpensive construction to thereby afford it the broadest possible market. Finally, it is also an objective that all of the aforesaid advantages and objectives be achieved without incurring any substantial relative disadvantage.

### SUMMARY OF THE INVENTION

The present invention is a system to control the output of a light source based on closed-loop feedback of the source's output, an external control setpoint input, and a history of the source's output at one or more time intervals. By modulating the actual output of the light source, the operational maximum output of the source is held constant throughout its useful life. The power consumed by the light source thus begins at the minimum level required for the application, and slowly rises to a maximum over time; this saves a significant amount of power compared to keeping the source at its true maximum power level over its entire operational life and allowing its output to decline, finally reaching a minimum acceptable level at the end of its operational life while still consuming its maximum power.

There is disclosed a light source controller which is coupled to a power supply, a light source having a predetermined operational lifetime, and a light sensor. The light source controller includes a controller housing, a control processor and a non-volatile memory unit.

The control processor is disposed in the controller housing and is coupled to the power supply, the light source, and the light sensor. The control processor is configured to modulate, in a closed-loop feedback of light source output the actual light output of the light source to be constant over the operational lifetime period of the light source.

The non-volatile memory unit is coupled to the controller processor and is configured to store light values associated with the light source used by the control processor to modulate the light output of the light source.

The light source controller may also have a first signal conditioning module coupled to the control processor and configured to receive and condition the light value output from the light sensor.

In another embodiment the light source controller includes a second signal conditioning module coupled to the control processor and is configured to receive a signal from an output control coupled to the second signal conditioning module.

The control processor of the light source controller is coupled to an enable input port and a set point input port of the power supply. The enable input port is configured to receive a signal from the control processor to energize the light source. The set point input port is configured to receive a signal from the control processor to direct the power supply to modulate the luminous flux output and power consumption of the power source to a level between 0 and 100% maximum output.

The light source controller is typically used with a light emitting diode type light source. Further, in some embodiments, the power supply is disposed within the controller housing and in other embodiments it is separate from the housing but coupled to the control processor.

There is further disclosed a lighting system. The lighting system includes a power supply coupled to a power source. The lighting system also includes a light source coupled to the power supply and a light sensor configured to receive luminous flux from the light source and ambient light from the environment in which the lighting system is used. The lighting system further includes a light source controller coupled to the power supply, the light source and the light sensor.

The light source controller includes a control processor disposed in a controller housing and coupled to the power supply, the light source, and a light sensor. The control processor is configured to modulate, in a closed-loop feedback of light source output, the actual light output of the light source to be constant over the operational lifetime period of the light source.

A non-volatile memory unit is coupled to the controller processor and is configured to store light values associated with the light source used by the control processor to modulate the light output of the light source.

The light source controller may also have a first signal conditioning module coupled to the control processor and configured to receive and condition the light value output from the light sensor.

In another embodiment the light source controller includes a second signal conditioning module coupled to the control processor and is configured to receive a signal from an output control coupled to the second signal conditioning module.

The control processor of the light source controller is coupled to an enable input port and a set point input port of the power supply. The enable input port is configured to receive a signal from the control processor to energize the light source. The set point input port is configured to receive a signal from the control processor to direct the power supply to modulate the luminous flux output and power consumption of the power source to a level between 0 and 100% maximum output.

The light source controller is typically used with a light emitting diode type light source. Further, in some embodiments, the power supply is disposed within the controller housing and in other embodiments it is separate from the housing but coupled to the control processor.

The apparatus of the present disclosure is of a construction which is both durable and long lasting, and which will require little or no maintenance to be provided by the user throughout its operating lifetime. The apparatus of the present disclosure is also of inexpensive construction to enhance its market appeal and to thereby afford it the broadest possible market.

### DESCRIPTION OF THE DRAWINGS

FIG. 1 is a block diagram of an exemplary embodiment of a light source controller associated with a light fixture.

FIG. 2 is a block diagram of an exemplary embodiment of the light source controller of FIG. 1 with power supply integrated with the controller associated with a light fixture.

FIG. 3 is a block diagram of an exemplary embodiment of a light source controller of FIG. 1 including a switching device.

FIG. 4A and FIG. 4B are functional block diagrams of the light source controller illustrated in FIGS. 1-3.

### DETAILED DESCRIPTION OF THE EXEMPLARY EMBODIMENTS

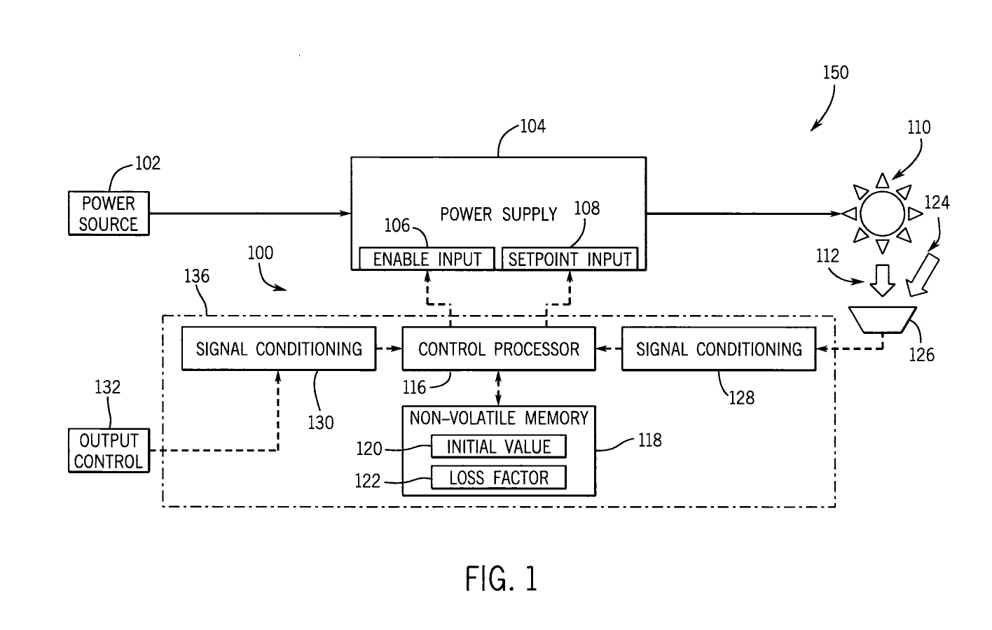

Referring now to the FIGS. 1-4B in more detail, in FIG. 1 there is illustrated an exemplary embodiment of a light source controller 100, a power source 102, a power supply 104 having an enable input port 106 and a setpoint input port 108, a light source 110, for example a light emitting diode (LED),a controller 114 including a control processor 116, non-volatile memory 118, and may include first and second signal conditioning modules 128 and 130.

For purposes of this disclosure, “light” is defined as that part of the electromagnetic spectrum having a wavelength or plurality of wavelengths between 360 nanometers and 800 nanometers, inclusive. Luminous flux (measured in lumens) is the sum of the radiant power (in Watts) of all wavelengths of light within a defined space, scaled to a standardized human visual response.

For purposes of this disclosure, an LED is a single light emitting diode package. An LED light source is an arrangement of one or more LEDs. For example, the LEDs may be arranged in a circle and mounted in an enclosure with a bezel, or the LEDs may be mounted on a circuit board and arranged linearly or in a matrix pattern as determined by a user or manufacturer. An LED lighting fixture is a lighting fixture that distributes light generated by a LED light source.

An analog or digital signal present (which may be a voltage level, current level, frequency-modulated voltage or current, pulse-width modulated voltage or current, or digital data stream) at the setpoint input port 108 of the power supply 104 directs the power supply 104 to modulate the luminous flux output and power consumption of the light source 110 to a level between zero and 100% of its maximum output given the architecture of the power supply 104.

The first and second signal conditioning modules 128 and 130 may consist of voltage-to-current, current-to-voltage, voltage- or current-to-frequency, pulse-width modulation-to-voltage or -current conversion, and/or other analog technique(s), and may be followed by sigma-delta, successive-approximation, ramp-compare, or other analog-to-digital conversion technique(s), or capture and storage of a digital data stream, as determined by a user.

The light source controller 100 includes a light sensor 126 and an output control 132. Sourced light 112 from the light source 110 and ambient light 124 are measured by the light sensor 126, stored in the non-volatile memory 118 and used by the control processor 116.

The output control 132 is configured to modulate the output of light source 110, and may include but is not limited to a wall dimmer switch, a room lighting control system, or a building automation system, which supplies an analog voltage or current level, a pulse-width-modulated voltage or current, a frequency-modulated voltage or current, or a digital data stream to the light source controller 100.

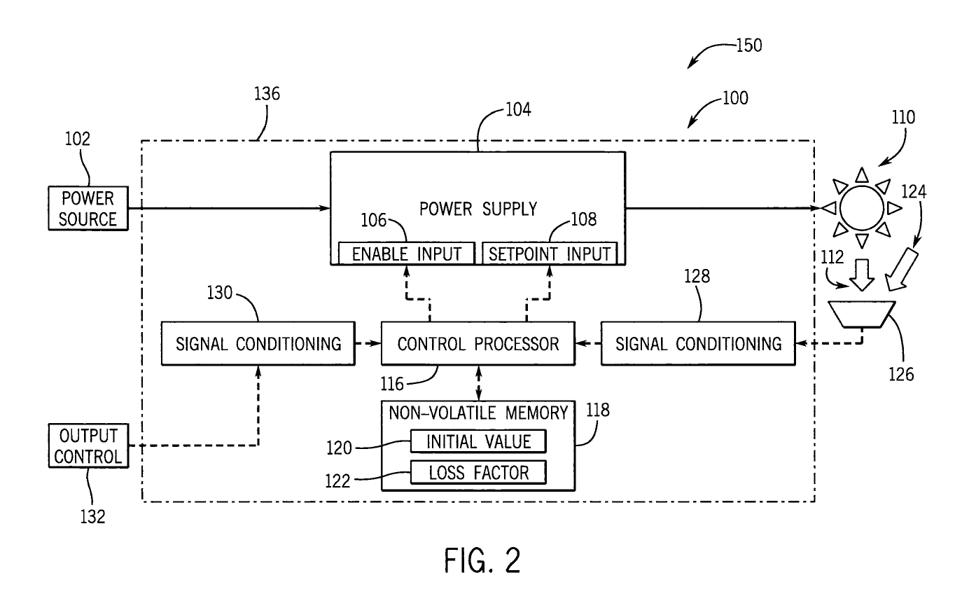

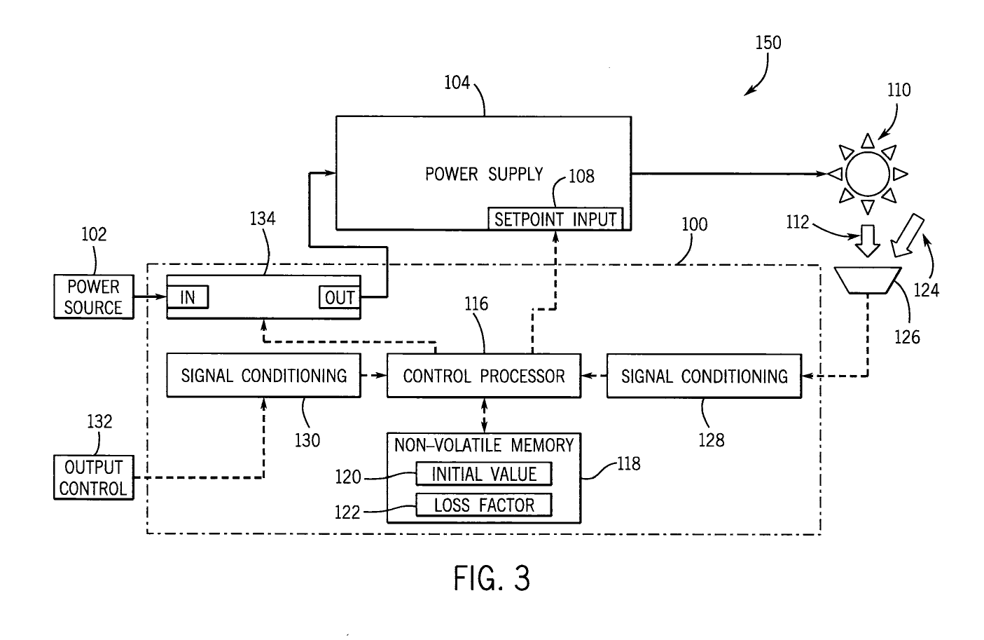

The power supply 104 in some embodiments is physically separated from but electrically connected to the controller 114 (See FIGS. 1 and 3). In other embodiments, the power supply 104 is disposed in a controller housing 136 (See FIG. 2).

In further detail, still referring to FIG. 1, the power source 102 provides electrical power to the power supply 104, which provides power to the light source 110. The power supply 104 turns the light source 110 on and off based on a signal received at its enable input 106, and modulates the output of the light source 110 to a value between zero and 100% based on the signal received at the setpoint input 108.

As illustrated in FIG. 1, the light sensor 126 receives sourced light 112 from the light source 110 and ambient light 124 from other sources that may be in the same environment but are not controlled by the light source controller 100. The output of the light sensor 126 passes through a first signal conditioning module 128 before it is received by the control processor 116. The signal from the output control 132 passes through a second signal conditioning module 130 before it is received by the control processor 116. The control processor 116 stores light values and related information to be retained regardless of the information status in the non-volatile memory 118.

Referring now to FIG. 2, there is shown an alternate exemplary embodiment of a light source controller 100. In this configuration the power supply 104 is included in a controller housing 136 with the controller 114.

Referring now to FIG. 3, there is shown another exemplary embodiment of a light source controller 100. In this configuration, the controller 114 includes a switching device 134, for example a manual throw switch, a relay, an electronic switch, for example a transistor or a solenoid, which controls the flow of electrical power from the power source 102 to the power supply 104. The switching device 134 may be external to the controller housing 136 or integral with the controller housing 136.

The configuration of the light source controller 100 as shown in FIG. 1 through FIG. 3 is such that the power source 102 may provide alternating current or direct current power to the power supply 104, and the power provided by the power supply 104 to the light source 110 may be alternating current or direct current as determined by the user or manufacturer. Further, the signal from the light sensor 136 and the output control 132 into the controller 114, and the signals from the control processor 116 to the enable input port 106 and the setpoint input port 108 of the power supply 104 may be alternating current, direct current, or digital signals, and may be transmitted through direct connections or through a wireless link which may include but is not limited to radio, infrared, or optical transmission.

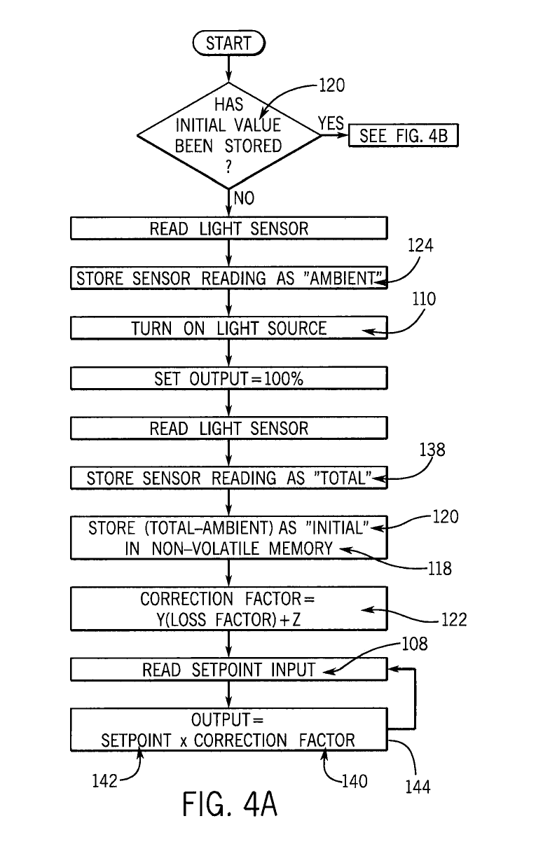

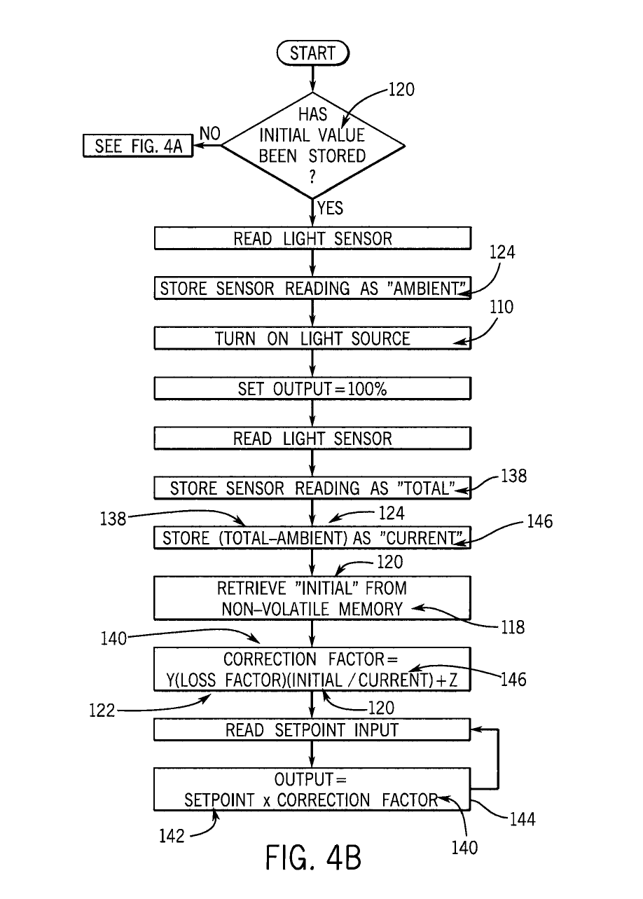

Referring now to FIG. 4A and FIG. 4B, there are shown procedural diagrams of the operation of an exemplary embodiment of a light source controller 100.

Referring to FIG. 1, at the start of an operation the power supply 104 is not providing power to the light source 110 even though the power source 104 may be providing power to the power supply 104. Ambient light 124 may strike the light sensor 126, but as the light source 110 is not energized no sourced light 112 is generated. The control processor 116 first determines if an INITIAL value 120 has been stored in non-volatile memory 118.

Referring to FIG. 1 and FIG. 4A, if an INITIAL value 120 has not been stored in non-volatile memory 118, the control processor 116 reads the output of the light sensor 126 and stores this value as AMBIENT 124. The control processor 116 then signals the power supply 104 through the enable input port 106 to energize the light source 110, and to modulate the output of the light source 110 to its maximum intended output level of 1000. At this point both ambient light 124 and sourced light 112 both strike the light sensor 126. The control processor 116 then reads the output of the light sensor 126 and stores this value as TOTAL 138. The control processor 116 then subtracts the value AMBIENT 124 from the value TOTAL 138 and stores this value as INITIAL 120 in non-volatile memory 118. The control processor 116 then reads the value of LOSS FACTOR 122 (L.F.) which is programmed into non-volatile memory 118 and calculates a value for a CORRECTION FACTOR 140 (C.F.) based on the equation

C.F.=Y(L.F.)+Z

where Y is equal to 0.01 in the illustrated configuration but may be any real number and Z is equal to zero but may be any real number. Y and Z are chosen such that the value of CORRECTION FACTOR 140 corresponds to the percentage of the maximum output of light source 110 represented by the value of LOSS FACTOR 122, which is the prorated maximum level to which the output of the light source 110 will be scaled during its operational life.

Now referring to FIG. 1 and FIG. 4B, if an INITIAL value 120 has been stored in non-volatile memory 118, the control processor 116 reads the output of the light sensor 126 and stores this value as AMBIENT 124. The control processor 116 then signals the power supply 104 through the enable input port 106 to energize the light source 110, and to modulate the output of the light source 110 to its maximum intended output level of 100%. At this point both ambient light 124 and sourced light 112 both strike the light sensor 126. The control processor 116 then reads the output of the light sensor 126 and stores this value as TOTAL 138. The control processor 116 then subtracts the value AMBIENT 124 from the value TOTAL 138 and stores this as CURRENT 146. The control processor 116 then reads the value of LOSS FACTOR 122 (L.F.) which is stored in the non-volatile memory 118 and calculates a value for a CORRECTION FACTOR 140 (C.F.) based on the equation

$$C . F . = Y ( L . F . ) ( \frac{INITIAL}{CURRENT} ) + Z$$

where Y is equal to 0.01 in the illustrated configuration but may be any real number and Z is equal to zero but may be any real number. Y and Z are chosen such that the value of CORRECTION FACTOR 140 increases as the output of the light source 110 decreases over time, such that the same prorated maximum output level is maintained throughout the operational life of the light source 110.

Still referring to FIG. 1 and FIG. 4B, once the CORRECTION FACTOR 140 has been calculated by the control processor 116, the control processor 116 reads the signal from the output control 132 and stores this value as SETPOINT 142. The control processor 116 then multiplies the value of SETPOINT 142 by the value of CORRECTION FACTOR 140 and stores this value as OUTPUT 144. The control processor 116 then transmits the value of OUTPUT 144 to the setpoint input port 108 of the power supply 104. Based on this value 144, power supply 104 modulates the output of light source 110 to an amount between zero and 100% of intended maximum. The control processor 116 then continuously reads the signal from the output control 132 and modifies the signal sent to the setpoint input port 108 of the power supply 104 in response to changes to the signal from the output control 132.

Some advantages of the disclosed light source controller 100 include, without limitation, that it allows a prorated maximum output of a light source 110, at some level below its actual maximum output, to be maintained over its operational lifetime, compensating for the tendency of the light source 110 to have a reduced output over time. Further, it allows the output of the light source 110 to be modulated using an output control in a manner that maintains consistent behavior over the operational lifetime of the light source 110. Further, the modulation of the light source 110 output is done in response to closed-loop feedback of its behavior under its actual operating conditions, rather than based on a predetermined profile.

The disclosed light source controller 100 is a controller that modulates the output of a light source 110 that decreases in output over time, such that the actual output of the light source 100 remains constant throughout its operational life.

In operation, the function of the system 100 will be as follows. An exemplary LED light fixture containing at least a light source 110 and a power supply 104 is coupled to a power source 102. When this fixture is first energized by power source 102, the controller 114 reads the actual maximum sourced light 112 of the light source 110 through a light sensor 126, turning the power supply 104 on and off through its enable output port 106 as needed to cancel out the effect of ambient light 124. The initial sourced light 112 output of the light source 110 is stored in memory 118. The controller 114 then reduces the allowable maximum output of the light source 119 to some level below 100% (for example, 70%). This has the effect of reducing the power consumed by the light source 110.

The controller 114 then scales the signal from the output control 132 such that when the output control 132 is set to its maximum value, the light source 110 is at (for example) 70% of its actual maximum output via control signals sent to the setpoint input port 108. As the sourced light 112 output of the light source 110 degrades with age, the controller 114 repeatedly measures the sourced light 112 output with the light sensor 126 to determine the decrease in actual maximum sourced light 112 output 118 compared to the initial maximum stored in memory 118, and gradually increases the allowable maximum power that is consumed by the light source 110 such that its allowable maximum light output, which is what is perceived by a user, remains the same throughout its operational lifetime.

The control processor 116 of the controller 114 may be a microprocessor or a microcontroller mounted on the same substrate as the LED light source components or in a separate housing mounted in the light fixture. The controller 114 may also be a server coupled to an array of peripherals or a desktop computer, or a laptop computer, or a smart-phone.

It is also contemplated that the controller 114 is configured to control more than one light fixture and may be remote from any of the light fixtures. Communication between the controller 114 and the light fixture may be either by hardwire or wireless devices. The memory/data base 118 may be remote from the controller 114. The controller 114 typically may include an input device, for example a mouse, or a keyboard, and a display device, for example a monitor screen or a smart phone. Such devices can be hardwired to the controller or connected wirelessly with appropriate software, firmware, and hardware. The display device may also include a printer coupled to the controller 114. The display device may be configured to mail or fax reports as determined by a user. The controller 114 may be coupled to a network, for example, a local area network or a wide area network, which can be one of a hardwire network and a wireless network, for example a Bluetooth network or internet network, for example, by a WI-FI connection or “cloud” connection.

Further, the total amount of power (kW-h) consumed by a light fixture incorporating the disclosed light source controller 100 is reduced compared to that of a light fixture that does not incorporate the disclosed controller 100. A light fixture incorporating the disclosed controller 100 will have consistent light output and gradually increasing power consumption over its life, whereas a standard light fixture will have consistent power and gradually reducing output over its life.

At the end of fixture life, as defined by industry standards, both the light source controller 100 equipped fixture and the standard fixture will have the same light output and the same power consumption. Prior to the end of fixture life, the fixture incorporating the controller 100 will have had a reduced power input compared to the standard fixture (thus saving energy), and the standard fixture will have a greater light output than necessary (thus over-lighting the space).

While the foregoing disclosure enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

For purposes of this disclosure, the term “coupled” means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or the two components and any additional member being attached to one another. Such adjoining may be permanent in nature or alternatively be removable or releasable in nature.

Although the foregoing description of the light source controller 100 has been shown and described with reference to particular embodiments and applications thereof, it has been presented for purposes of illustration and description and is not intended to be exhaustive or to limit the disclosure to the particular embodiments and applications disclosed. It will be apparent to those having ordinary skill in the art that a number of changes, modifications, variations, or alterations to the disclosure as described herein may be made, none of which depart from the spirit or scope of the present disclosure. The particular embodiments and applications were chosen and described to provide the best illustration of the principles of the controller and its practical application to thereby enable one of ordinary skill in the art to utilize the controller in various embodiments and with various modifications as are suited to the particular use contemplated. All such changes, modifications, variations, and alterations should therefore be seen as being within the scope of the present disclosure as determined by the appended claims when interpreted in accordance with the breadth to which they are fairly, legally, and equitably entitled.

What is claimed is:

1. A light source controller coupled to a power supply, a light source having a predetermined operational lifetime period, and a light sensor, the light source controller comprising:
a controller housing;
a control processor disposed in the controller housing and coupled to the power supply, the light source, and the light sensor, the control processor configured to modulate, in a closed-loop feedback of the light source output, the actual light output of the light source to be constant over the operational lifetime period of the light source; and,
a non-volatile memory unit coupled to the controller processor and configured to store light values associated with the light source used by the control processor to modulate the light output of the light source.

2. The light source controller of claim 1, a first signal conditioning module coupled to the control processor and configured to receive the light value output from the light sensor.

3. The light source controller of claim 1, a second signal conditioning module coupled to the control processor and configured to receive a signal from an output control coupled to the second signal conditioning module.

4. The light source controller of claim 3, wherein the output control is one of a wall dimmer switch, a room lighting control system, and a building automation system.

5. The light source controller of claim 1, further comprising the control processor is coupled to an enable input port and a setpoint input port of the power supply, with the enable input port configured to receive a signal from the control processor to energize the light source, and with the setpoint input port configured to receive a signal from the control processor to direct the power supply to modulate the luminous flux output and power consumption of the light source to a level between zero and 100% of maximum output.

6. The light source controller of claim 1, wherein the light source is a light emitting diode.

7. The light source controller of claim 1, including a switching device coupled to the power supply and the control processor and configured to control flow of electrical power from a power source and the power supply.

8. The light source controller of claim 1, wherein the power supply is disposed within the controller housing.

9. A lighting system comprising:
a power supply coupled to a power source;
a light source coupled to the power supply;
a light sensor configured to receive luminous flux from the light source and ambient light; and
a light source controller coupled to the power supply, the light source, and the light sensor, the light source controller comprising:
a controller housing;
a control processor disposed in the controller housing and coupled to the power supply, the light source, and the light sensor, the control processor configured to modulate, in a closed-loop feedback of the light source output, the actual light output of the light source to be constant over the operational lifetime period of the light source; and,
a non-volatile memory unit coupled to the controller processor and configured to store light values associated with the light source used by the control processor to modulate the light output of the light source.

10. The lighting system of claim 9, a first signal conditioning module coupled to the control processor and configured to receive the light value output from the light sensor.

11. The lighting system of claim 9, a second signal conditioning module coupled to the control processor and configured to receive a signal from an output control coupled to the second signal conditioning module.

12. The lighting system of claim 11, wherein the output control is one of a wall dimmer switch, a room lighting control system, and a building automation system.

13. The lighting system of claim 9, further comprising the control processor is coupled to an enable input port and a setpoint input port of the power supply, with the enable input port configured to receive a signal from the control processor to energize the light source, and with the setpoint input port configured to receive a signal from the control processor to direct the power supply to modulate the luminous flux output and power consumption of the light source to a level between zero and 100% of maximum output.

14. The lighting system of claim 9, wherein the light source is a light emitting diode.

15. The lighting system of claim 9, including a switching device coupled to the power supply and the control processor and configured to control flow of electrical power from a power source and the power supply.

16. The lighting system of claim 9, wherein the power supply is disposed within the controller housing.
